(19) United States
(12) Patent Application Publication
(10) Pub. No.: US 2004/0033742 A1
(43) Pub. Date: Feb. 19, 2004

(54) Fluoropolymer compound plate

(76) Inventors: Amber Ho, Taipei (TW); Roger Chang, Taipei (TW)

Correspondence Address: Amber Ho, 235 Chung - Ho Box 8-24, Taipei, TW

(21) Appl. No.: 10/374,201

(22) Filed: Feb. 27, 2003

(30) Foreign Application Priority Data
Aug. 13, 2002 (TW) 91212494

(51) Int. Cl. B32B 27/12; B32B 27/04

(52) U.S. Cl. 442/40; 442/38

(57) ABSTRACT

A fluoropolymer compound plate comprises a fluoropolymer sheet; and a medium welded with a net having a low expansion coefficient; then the fluoropolymer sheet combined with the net through welding operation so as to be formed as a fluoropolymer compound plate. The medium is a welding film. Another surface of the net not welded to the fluoropolymer sheet is welded with a piece of fabric cloth through another medium for being combined with another material.

### FIELD OF THE INVENTION

The present invention relates to fluoropolymer compound plates which comprises a fluoropolymer sheet; and a medium being welded with a net having a low expansion coefficient; then the fluoropolymer sheet combined with the net through welding operation so as to be formed as a fluoropolymer compound plate.

### BACKGROUND OF THE INVENTION

General used fluoropolymer materials include polytetrafluoroethylene (PTFE), copolymer of polytetrafluoroethylene and perfluoropropylvinyl ether (PFA); copolymer of polytetrafluoroethylene and hexfluoropropolene (FEP); copolymer of tetrafluoroethylen and ethylene (ETFE); polytrifloruchloroethylene (PCTFE); copolymer of trifluorochlorothylene and ethylene (ECTFE); polymetadifluoroethylene (PVDF), etc. for storing chemical products so as to maintain the purity of wear-tolerant chemicals.

Unluckily, the fluoropolymer compound plates have high expansion coefficients so that the equipment made of these fluoropolymer compound plates are easily deformed due to heat so that the equipment are as good as desired, even the equipment is failed.

### SUMMARY OF THE INVENTION

Accordingly, the primary object of the present invention is to provide a fluoropolymer compound plate which comprises a fluoropolymer sheet; and a medium being welded with a net having a low expansion coefficient; then the fluoropolymer sheet combined with the net through welding operation so as to be formed as a fluoropolymer compound plate. The medium is a welding film. Another surface of the net not welded to the fluoropolymer sheet is welded with a piece of fabric cloth through another medium for being combined with another material.

The various objects and advantages of the present invention will be more readily understood from the following detailed description when read in conjunction with the appended drawing.

### BRIEF DESCRIPTION OF THE DRAWINGS

FIG. 1 is an exploded view of the fluoropolymer compound plate of the present invention.

FIG. 2 is a cross section view of the fluoropolymer compound plate of the present invention.

### DETAILED DESCRIPTION OF THE PREFERRED EMBODIMENTS

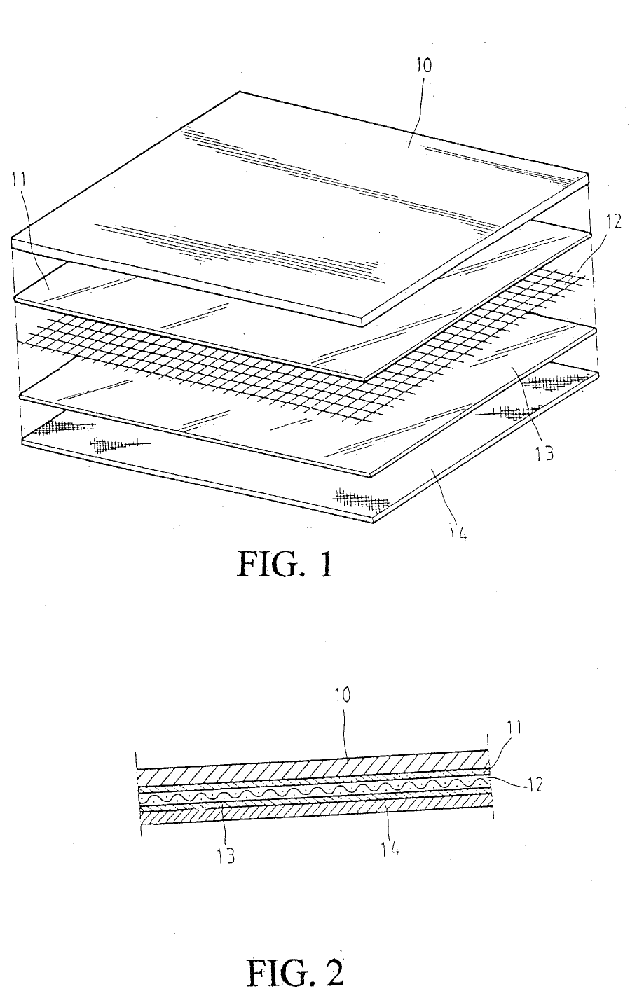

Referring to FIG. 1, the fluoropolymer compound plate of the present invention is illustrated. The fluoropolymer compound plate includes a fluoropolymer sheet 10. A medium 11 is welded with a net 12 having a low expansion coefficient. The medium 11 is a welding film. Then the fluoropolymer sheet is combined with the net 12 through welding operation.

The net 12 has a low expansion coefficient, which may be metal or non-metal material. The net 12 serves to shape the fluoropolymer sheet. The plate serves to improve the deformity in high temperature environment. The deformity of the net 12 is based on the diameter of the wires forming the net 12 or the gaps in the net 12 so as to control the cost.

An experience of above said material is executed as the following description.

The following samples are taken in the experience: polytetrafluoroethylene plate; polytetrafluoroethylene resin glass fiber; copolymer resin glass fiber of tetrafluoroethylene and perfluorovinyl acid; and copolymer of polytetrafluoroethylene plate welded with a metal net. The testing conditions are that the testing material is placed in an electric furnace for heating through 2 hours, and variations of sizes are measured.

The testing resulting is:

| | Length before | Length after | Variation | Expansion |
|---|---|---|---|---|
| Sample No. | heating | heating | Of Length | Coefficient |
| (1) | 200 mm | 205.64 mm | 5.64 mm | 1.41*E−4 |
| (2) | 200 mm | 204.76 mm | 4.76 mm | 1.19*E−4 |
| (3) | 200 mm | 205.17 mm | 5.17 mm | 1.29*E−4 |
| (4) | 200 mm | 202.72 mm | 2.72 mm | 6.80*E−5 |

From above tests, it is clearly that the fluoropolymer compound plate (sample of No. (4)) can effectively reduce the heat expansion coefficient as compared with the sample of No. 1. Thereby, the fluoropolymer compound plate of the present invention can have less heat deformation as in high temperature environment so as to the equipment can be used safely.

In another preferable embodiment of the present invention, at another surface of the net 12 not welded to the fluoropolymer sheet 10 is welded with a piece of fabric cloth 14 through another medium 14 for being combined with another material. Thereby, the stability of the fluoropolymer sheet 10 in high temperature can be increased.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A fluoropolymer compound plate comprising
a fluoropolymer sheet;
a medium being welded with a net having a low expansion coefficient; then the fluoropolymer sheet combined with the net through welding operation so as to be formed as a fluoropolymer compound plate.

2. The fluoropolymer compound plate as claimed as claim 1, wherein the medium is a welding film.

3. The fluoropolymer compound plate as claimed as claim 1, wherein another surface of the net not welded to the fluoropolymer sheet is welded with a piece of fabric cloth through another medium for being combined with another material.
